(19) United States
(12) Patent Application Publication
(10) Pub. No.: US 2003/0006051 A1
(43) Pub. Date: Jan. 9, 2003

(54) Percussion electrical hand-held power tool with active vibration damping

(76) Inventors: Harald Schmitzer, Wasserburg (DE); Stefan Tichy, Frastanz (AU); Roland Schaer, Grabs (CH)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/154,327

(22) Filed: May 22, 2002

(30) Foreign Application Priority Data
Jun. 21, 2001 (DE) 101 30 088.3

(51) Int. Cl. B25D 1/00

(52) U.S. Cl. 173/49; 173/2

(57) ABSTRACT

An electrical hand-held power tool including an arrangement for actively damping vibrations applied to the tool handle (2) and arranged between the handle and the hammer mechanism module (3) with a possibility of a limited axial displacement along the percussion axis (A) with respect to the hammer mechanism module (3) and having at least one electromechanical actuator (5a, 5b) surrounded by an elastic spring (8a, 8b), a sensor for sensing vibrations acting on the handle (2), and a microprocessor (7) for dynamically controlling the actuator (5a, 5b) in accordance with the signal generated by the sensor.

### BACKGROUND OF THE INVENTION

1. Field of the Invention

The present invention relates to a percussion electrical hand-held tool, such as a hammer drill or a chisel hammer, with an active vibration damping of the power tool handle.

2. Description of the Prior Act

As a result of interaction with a workpiece of a working tool, the handle of the power tool that percussively drives the working tool is preloaded, as a result of gravitation and a pressure applied by a user to the handle of the power tool and is subjected to axial oscillations which should be prevented as much as possible. These oscillations result from the rebound of the working tool, the recoil of the hammer mechanism, and the vibration of the unbalanced eccentric mass. The main or primary oscillation, which takes place parallel to the percussion axis, should have a weighted acceleration average that, for protection of the power tool user, should not exceed 2.5 m/s². Therefore, this vibration limits the power of a percussion electrical hand-held tool.

British Publication GB-2154497 discloses an electrical hand-held tool in which a heavy, oscillation-isolated housing module, which is supported for a limited axial movement along the percussion axis with respect to a hammer mechanism module with a hammer mechanism, is connected with the handle and an auxiliary handle. The vibrations or oscillations are actively damped by viscoelastic damping means arranged in the housing module.

U.S. Pat. No. 5,322,131 discloses a pneumatic percussion tool which is provided with active, compressed air-controlled vibration damping means and in which a U-shaped handle is arranged on a frictionlessly supported, cup-shaped handle housing part capable of limited axial displacement.

German Publication DE-35 21 898 discloses a tool in which in the displacement region of a pressure-loaded handle capable of a limited axial displacement, an almost constant counter-force, which is applied to the handle, is electromagnitically generated by moving coils that act as electromechanical actuators. The movement of coils is controlled by direct current. As a result of application of the counter-force to the handle, the handle is subjected to action of a constant force. For the compensation of the position of the handle, there are provided sensors which integrally control the distance between the handle and the tool housing. The electromechanical actuators must provide for the application of the entire counter-force to the handle and, therefore, they should necessarily have relatively large dimensions, with the voltage source likewise being relatively large. As a result, the actuators and the voltage source have large volume and weight which contribute to the total volume and weight of the tool that can only be increased up to a certain limit.

German Publication DE 196 46 622 discloses a tool in which a counter-force acting on a pressure-loaded handle or the position of the handle is controlled by a microprocessor which emits a control signal in response to a signal generated by a vibration-sensing sensor. The control of the counter-force and/or the position is effected via force-generating moving coils that act as electromechnical actuators. The vibrations, which are registered by the sensor, are compensated by directly excited counter-vibrations, i.e., an active regulation takes place. The electromechnical actuators are arranged in a row with viscoelastic dampening elements and, as a result, should provide for application of the entire counter-force to the handle which likewise results in increase of the size of the actuators and their voltage source.

Accordingly, an object of the present invention is to provide vibration damping means for damping the vibration applied to the handle of a hand-held percussion power tool and which would include electromechnical actuators and a voltage source having sufficiently small dimensions.

### SUMMARY OF THE INVENTION

This and other objects of the present invention, which will become apparent hereinafter, are achieved by providing a electrical hand-held power tool for generating a percussion load applied to a working tool along a percussion axis and including a handle, an oscillating hammer mechanism module, and an arrangement for actively damping vibrations applied to the handle, arranged between the handle and the hammer mechanism module with a possibility of a limited axial displacement along the percussion axis with respect to the hammer mechanism module, and having at least one electromechanical actuator, at least one elastic spring bridging the at least one actuator, a sensor for sensing vibrations acting on the handle, and a microprocessor for dynamically controlling the at least one electromechanical actuator for reducing the vibrations acting on the handle in accordance with a signal generated by the sensor.

As a result of the provision, with respect to the force flux, of a spring, which is arranged at least partially parallel to the actuator, the force flux is divided between the spring and the actuator. Therefore, the electromechanical actuator provides for application to the handle only a portion of the counter-force necessary to achieve a balance of forces acting on the handle. As result, the actuator can have smaller dimensions. Correspondingly, the power source for the electromechanical actuators likewise can be made smaller. Preferably, the power source is formed as an electronic circuit breaker. An optimal control function for controlling the actuators would include a control which would take into account, optionally, sensor-measurable parameters such as the orientation of the power tool, oscillation amplitude of the hammer mechanism module, average force acting on the handle, and other parameters specific for the power tool and which are read-out by the microprocessor from storage means and/or are calculated by the microprocessor.

Advantageously, the spring is a high-quality spring and, in particular, is not viscoelastic. Therefore, the electromechnical actuators need not overcome any additional passive damping. Further, advantageously, guide bearings, which provide for the limited axial movement, are formed so that there is substantially no friction between the movable parts. E.g., the guide bearings can be formed as spherical sleeves and as slide bearings.

Advantageously, the electromechanical actuator is arranged parallel to the percussion axis. Thereby, the control system can be made technologically simple, without any additional constructive measures, for effecting an active vibration damping.

Advantageously, the electromechanical actuator is so formed that it operates in both compression and tension regions. As a result, the actuator should balance only the minimal dynamic force difference which is directly produced by the vibrations. Therefore, the electromechnical actuator can have smaller dimensions with regard to the power to the tool.

Advantageously, the spring is formed as a compression spring extending along the percussion axis. Therefore, a substantial portion of the press-on force applied by the user can be directly and technologically simply absorbed without any additional measures. Advantageously, the stiffness of the spring amounts to from about 30 to about 50 N/mm.

Advantageously, the elastic spring and the electronic mechanical actuator are coaxially arranged and form together a damping module, with the elastic spring being formed as a self-supporting helical spring wound about the electromechanical actuator.

The formation of a damping module of the spring and the actuator permits to obtain a compact unit and without any bending or transverse moment.

Advantageously, there are provided two, spaced from each other, along a line transverse to the percussion axis, actuators or damping modules which are, advantageously, are associated, respectively, with the legs of the handle formed as a U-shaped handle.

Advantageously, the two electromechnical actuators or the two damping modules are arranged in a plane in which after a primary vibration, a second largest secondary vibration occurs. The two damping modules are separately controlled by the microprocessor. As a result of the difference of actions of the two actuators or damping modules in the plane of the actuators, damping modules, and due to the spacing between the actuators, damping modules, the secondary vibrations, which act in another, than axial, direction, are also actively damped. With a third actuator or a damping module, which is arranged outside of the plane of the first two actuators or damping modules, the vibrations in all of the spacial directions are actively damped.

Advantageously, the mass of the hammer module is made as large as possible and, in particular, larger than the other modules or units, which permits to increase the power of the hand-held power tool.

Advantageously, the side additional handle is also damped, with the additional handle being rigidly connected with the handle by a handle U-shaped housing part vibrations of which are actively damped.

Advantageously, other, conventional means for a passive reduction of vibrations applied to the handle, such as viscoelastic material which are, used for attachment and/or during formation of the handle, is combined with the active damping means according to the present invention. As a result, additional particular vibration or oscillation frequencies above the actively damped frequency spectrum are damped.

Advantageously, the control circuit, which is formed of sensors, microprocessor, and actuator, is designed for active control or regulation in the region of from 10 to 100 Hz, preferably, in the region of from 2 to 400 Hz, at a sampling time of less than 1 ms, advantageously, less than 200 us.

Advantageously, the control circuit is based on one of the following control principle: feedforward, feedback, or mixed principle, preferably, with a feedback.

a) When a feedback principle is used, the acceleration of the handle is measured with PT-1 controller (proportional low-pass controller) and is transmitted back to the actuators as a control voltage by a phase-changing member. The object of the control is obtaining of mill-set value for the acceleration. The circuit can be formed with one or two sensors.

b) Feedback of the tool acceleration and the counter-electromotive force (EMF).

As it advantageous to place the sensor on an electronic plate mounted on the tool, with this embodiment, an inverse induction that takes place in the actuator during a relative movement of the coil with respect to the magnet, is used. This inverse induction can be calculated from the ratio of the current to the voltage and from the actuator parameters (inductance and resistance). As in the idle position of the handle, this relative movement is determined only by the tool movement, and is again calculated by integration based on an available acceleration data, the inverse induction can be controlled proportionally to the tool speed.

c) Feedforward of the tool acceleration

In case when a very small friction or a constant friction occurs in bearing means, it is advantageous to use a feedforward control. This is because the measurable tool acceleration produces always the same action on the handle mass which can be compensated by a feedforward control circuit. The advantage of the feedforward control consists in that a reliable stability can be obtained which cannot be insured by the feedback control circuit.

d) Feedback with distance information

With this control, the distance between non-interacting masses is measured and is transformed into a control voltage by the feedback control circuit.

e) Feedback of the force between the handle and the tool

Alternatively to the handle acceleration, according to an advantageous embodiment, the force applied to the handle is measured and by using a high-pass filter in controlled to 0 to keep the handle in a constant position.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawing.

### BRIEF DESCRIPTION OF THE DRAWINGS

In the Drawings:

FIG. 1 shows a principle layout of an electrical percussion, handheld power tool with an active vibration damping according to the present invention.

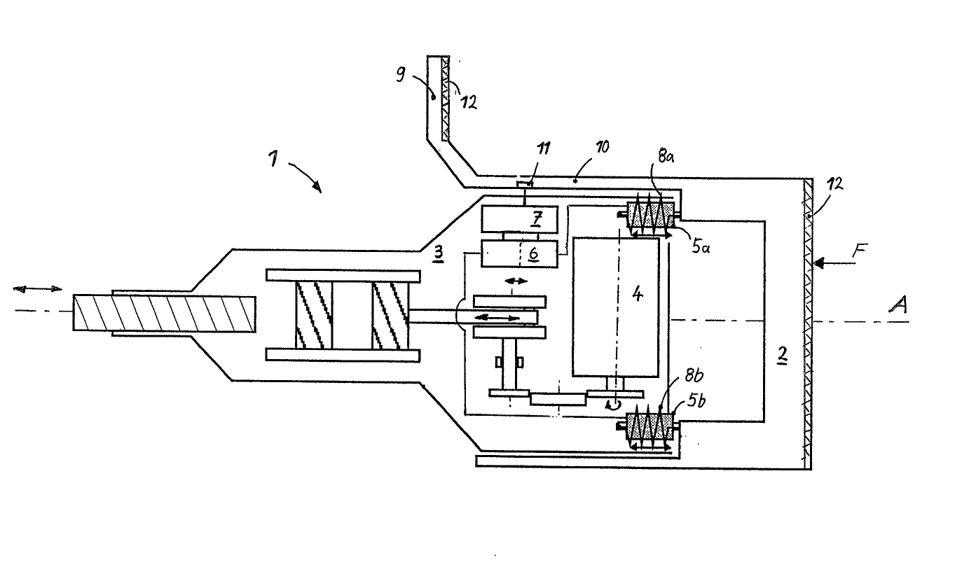

### DETAILED DESCRIPTION OF THE PREFERRED EMBODIMENT

An electrical hand-held power tool 1 according to the present invention, which is shown in the drawing and percussively oscillates along a percussion axis A, is provided with means for actively damping the vibrations of a handle 2 to which a press-on force F is applied. The vibration damping means is supported for a limited displacement along the percussion axis A with respect to an oscillating hammer mechanism module 3 having a pneumatic, eccentrically driven hammer mechanism and a driving motor 4.

The vibration damping means is arranged between the handle 2 and the oscillating hammer mechanism module 3 and includes two electromechnical actuators 5a, 5b which operate in compression and tension regions. The actuator 5a, 5b are arranged in a plane of the handle 2, parallel to the percussion axis A, and are spaced from each other along a line extending perpendicular to the percussion axis A. The actuators 5a, 5b are formed as oscillation coils and are connected with a microprocessor 7 by a driver 6. There are further provided two, non-dumped, elastic springs 8a, 8b which surround respective actuators 5a, 5b. The springs 8a, 8b are formed as helical springs and form, together with respective actuators 5a, 5b, two damping modules. An auxiliary handle 9 is fixidly connected with the handle 2 by a handle cup-shaped housing part 10. A sensor 11, which is formed as an acceleration pick-up, is provided in the housing part 10. The sensor 11 is operationally connected with the microprocessor 7 for transmitting signals thereto. Both, the auxiliary handle 9 and the handle 2 are covered additionally with a passive, viscoelastic outer damping layer 12.

Though the present invention was shown and described with references to the preferred embodiment, such is merely illustrative of the present invention and is not to be construed as a limitation thereof, and various modifications to the present invention will be apparent to those skilled in the art. It is, therefore, not intended that the present invention be limited to the disclosed embodiment or details thereof, and the present invention includes all of variations and/or alternative embodiments within the spirit and scope of the present invention as defined by the appended claims.

What is claimed is:

1. An electrical hand-held power tool for generating a percussion load applied to a working tool along a percussion axis (A), the power tool comprising a handle (2); an oscillating hammer mechanism module (3); and means for actively damping vibrations applied to the handle (2) and arranged between the handle and the hammer mechanism module (3) with a possibility of a limited axial displacement along the percussion axis (A) with respect to the hammer mechanism module (3), the vibration damping means comprising at least one electromechanical actuator (5a, 5b), at least one elastic spring (8a, 8b) bridging the at least one actuator (5a, 5b), a sensor (11) for sensing vibrations acting on the handle (2), and a microprocessor (7) for dynamically controlling the at least one actuator (5a, 5b) for reducing the vibrations acting on the handle (2) in accordance with a signal generated by the sensor.

2. An electrical hand-held power tool according to claim 1, wherein the elastic spring (8a, 8b) is non-damped, and the vibration damping means is supported for a substantially friction-free limited axial displacement.

3. An electrical hand-held power tool according to claim 1, wherein the at least one electromechanical actuator (5a, 5b) is arranged parallel to the percussion axis (A).

4. An electrical hand-held power tool according to claim 1, wherein the electromechanical actuator (5a, 5b) is formed for operation in compression and tension regions.

5. An electrical hand-held power tool according to claim 1, wherein the at least one elastic spring (8a, 8b) is formed as a compression spring.

6. An electrical hand-held power tool according to claim 5, wherein the at least one elastic spring (8a, 8b) has a stiffness in a range from about 30^{N}/mm to about 50^{N}/mm.

7. An electrical hand-held power tool according to claim 1, wherein the at least one elastic spring (8a, 8b) and the at least one electromechanical actuator (5a, 5b) are coaxially arranged and form together a damping module.

8. An electrical hand-held power tool according to claim 7, wherein the at least one elastic spring (8a, 8b) is formed as a self-supporting helical spring wound about the electromechanical actuator.

9. An electrical hand-held power tool according to claim 7, wherein the damping means comprises a further electromechanical actuator (8a, 8b) and a further elastic spring (8a, 8b) surrounding the further electromechanical actuator (5a, 5b) and forming therewith a further damping module spaced from the damping module, which is formed by the at least one elastic spring and the at least one electromechanical actuator, along a line extending perpendicular to the percussion axis (A).

10. An electrical hand-held power tool according to claim 9, wherein the handle (2) is formed as a U-shaped handle, and each damping module is associated with a respective leg of the U-shaped handle.

11. An electrical hand-held power tool according to claim 9, wherein both damping modules are arranged in a plane in which after a primary vibration, a second largest secondary vibration occurs.

12. An electrical hand-held power tool according to claim 9, wherein the two damping modules are separately controlled by the microprocessor.

13. An electrical hand-held power tool, according to claim 1, further comprising a side, additional handle (9) with damped vibrations.

14. An electrical hand-held power tool according to claim 13, wherein the additional handle (9) is rigidly connected with the handle (2) by a handle cup-shaped housing part (10) vibrations of which are actively damped.

15. An electrical hand-held power tool according to claim 1, wherein the sensor (11), the microprocessor (7), and the at least one electromechanical actuator (5a, 5b) form a control circuit for effecting an active control in a region from 10 Hz to 100 Hz at a sampling time of less than 1 ms.

16. An electrical hand-held power tool according to claim 1, wherein the sensor (11), the microprocessor (7), and the at least one electromechanical actuator (5a, 5b) form a control circuit for effecting an active control in a region from 2 Hz to 400 Hz at a sampling time of less than 1 ms.

17. An electrical hand-held power tool according to claim 1, wherein the sensor (11), the microprocessor (7), and the at least one electromechanical actuator (5a, 5b) form a control circuit for effecting an active control in a region from 10 Hz to 100 Hz at a sampling time of less than 200 us.

18. An electrical hand-held power tool according to claim 1, wherein the sensor (11), the microprocessor (7), and the at least one electromechanical actuator (5a, 5b) form a control circuit for effecting an active control in a region from 2 Hz to 400 Hz at a sampling time of less than 200 us.
